(19) United States
(12) Patent Application Publication
(10) Pub. No.: US 2013/0066579 A1
(43) Pub. Date: Mar. 14, 2013

(54) ANALYSIS METHOD FOR STORAGE MEDIUM

(71) Applicant: Kun-Lin LEE, Tu-Cheng (TW)

(72) Inventor: Kun-Lin LEE, Tu-Cheng (TW)

(73) Assignee: HON HAI PRECISION INDUSTRY CO., LTD., Tu-Cheng (TW)

(21) Appl. No.: 13/572,659

(22) Filed: Aug. 12, 2012

(30) Foreign Application Priority Data
Sep. 9, 2011 (TW) 100132772

(51) Int. Cl. G06F 15/00; G01M 7/04

(52) U.S. Cl. 702/113; 702/186

(57) ABSTRACT

A method is provided for analyzing a plurality of storage mediums in a server unit. A predetermined value is set according to a type of a storage medium. A first result and a second result generated by testing the storage medium in a first test and a second test are stored. A keyword is set for reading a first value and a second value from the first result and the second result. A ratio between the second value and the first value is computed to generate a third value for determining whether the third value is smaller than the predetermined value. Thereby, the third value is marked when the third value is smaller than the predetermined value.

### BACKGROUND

1. Technical Field

The present disclosure relates to an analysis method, and particularly to an analysis method for analyzing storage mediums in a server.

2. Description of Related Art

There are many hard disk drives, for example more than twenty hard disk drives, in a conventional server, so the number of log files storing test results may be more than hundred after the hard disk drives are tested for their performance by test software. However, if the log files are analyzed by a human, it will involve a lot of time and resources. In addition, the performance of the hard disk drives may be misjudged due to negligence during analyzing the test log files.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a data structure diagram of an analysis method of the present disclosure.

FIG. 2 is a flowchart of an embodiment of an analysis method of the present disclosure.

### DETAILED DESCRIPTION

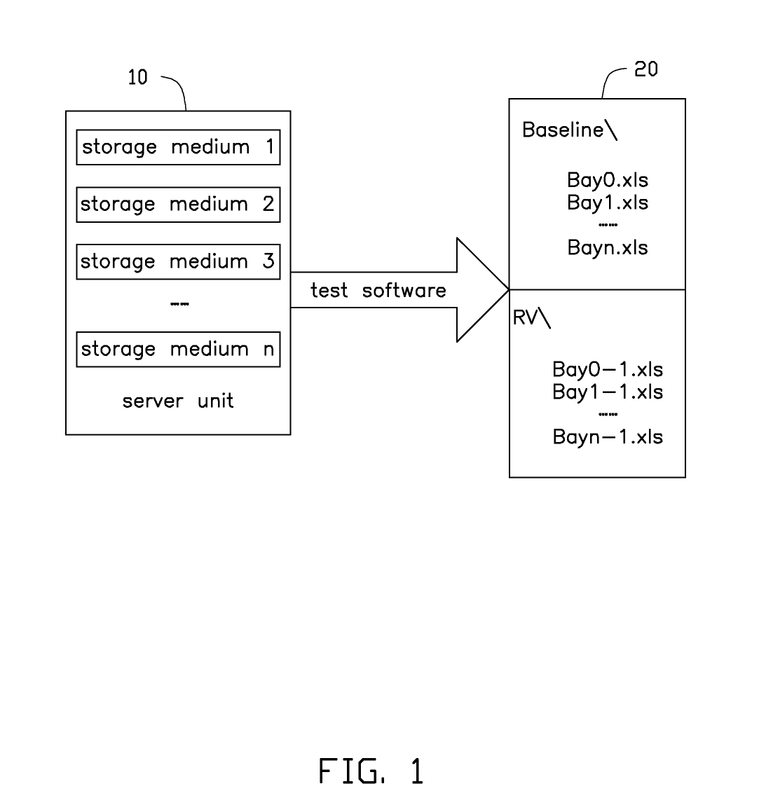

FIG. 1 is a data structure diagram of an analysis method of the present disclosure. The analysis method of the present disclosure analyzes a plurality of log files generated by a test software, wherein the log files stores test results generated by testing storage mediums 1-N in a server unit 10 for their performance. The log files are stored in a directory 20. The test software can test a storage medium. The storage medium is tested to show performance of the storage medium, such as read/write abilities and throughput.

When the storage mediums 1-N in the server unit 10 are operated at the same time, the read/write abilities of the storage mediums 1-N may be decreased due to both internal and external factors. The internal factors, such as vibrations generated by the storage mediums 1-N during operation and rotational vibrations generated by a fan, are internally generated in the server unit 10 and influence the performance of the storage mediums 1-N. The external factors are generated from external interference sources, such as an external vibration source vibrating outside of the server unit 10. For example, the external vibration source might be other operating server units. Due to interference of the internal and external factors, the performance of the server unit 10 is also decreased. Therefore, the storage mediums 1-N should be put in a baseline test and a rotational vibration test when the storage mediums 1-N are tested and analyzed.

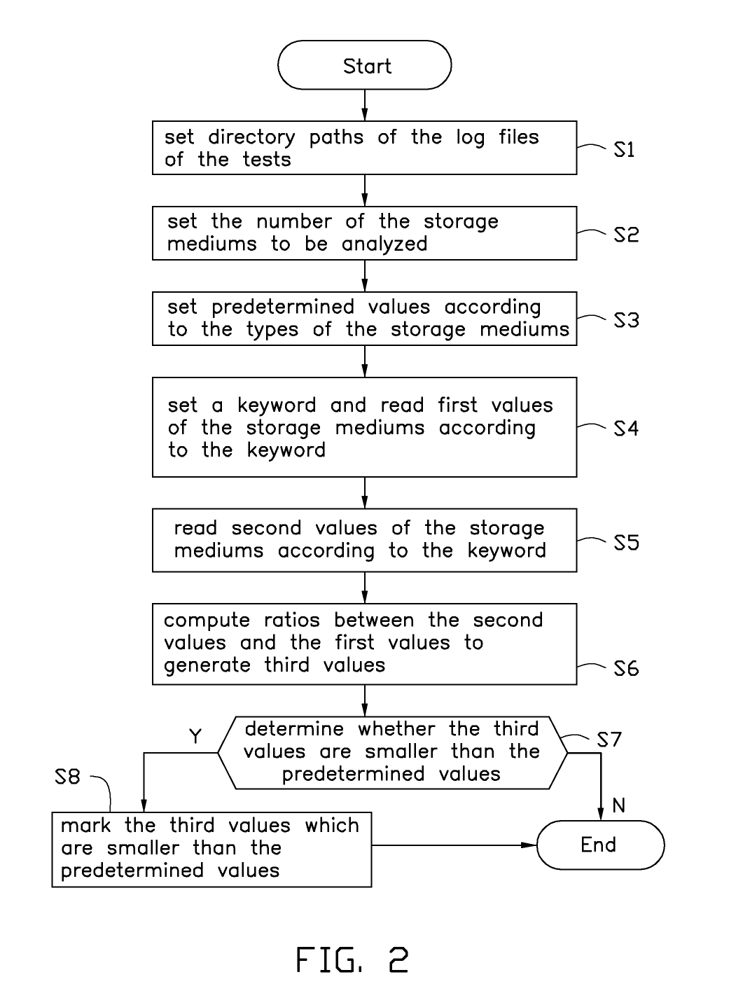

As shown in FIG. 2, an embodiment of the analysis method is as follows:

In step S1, directory paths of the log files of the tests are set. In the embodiment, the test software puts the storage mediums 1-N of the server unit 10 in the baseline test and the rotational vibration test in order to accurately measure performances of the storage mediums and store test results of the storage mediums.

When the baseline test is run, only one of the storage mediums in the server unit 10 is being operated. Thus, the test software tests the operated storage medium to measure its performance, generates a log file for a first result, and renames the log file to store in a first sub-directory, such as a baseline sub-directory. For example, a first log file generated by putting the storage medium 1 in the baseline test is renamed as Bay 0, and a second log file generated by putting the storage medium 2 in the baseline test is renamed as Bay 1.

When the rotational vibration test is run, each of the storage mediums in the server unit 10 is being operated. The test software tests one of the storage mediums 1-N to measure its performance, generates a log file for a second result, and renames the log file to store in a second sub-directory, such as a RV sub-directory. For example, a third log file generated by testing the storage medium 1 in the rotational vibration test is renamed as Bay 0-1, and a forth log file generated by testing the storage medium 2 in the rotational vibration test is renamed as Bay 1-1.

The test results of the baseline test and the rotational vibration tests are necessary when analyzing the performances of the storage mediums. Part of the test results stored in the log files is listed in Table 1 as follows.

| Test | Test | | Read | Write |
|---|---|---|---|---|
| Object Type | Object Name | IOps | IOps | IOps |
| LOAD | PC-1 | 165.4697 | 0 | 165.4697 |
| COMPUTER | | | | |
| DISK | PHYSICALDRIVE:1 | 165.4697 | 0 | 165.4697 |

In the test software, a test configuration of the test software is necessary before testing the performances of the storage mediums. The phrase “Test Object Type” in Table 1 is type of a test object, the phrase “Test Object Name” is name of the test object, the phrase “IOps” is an average number of input/output operations per second, the phrase “read IOps” is an average number of read input/output operations per second, and the phrase “write IOps” is an average number of write input/output operations per second. The phrase “LOAD COMPUTER” in Table 1 means a user terminal whose name is PC-1. The phrase “disk” means a storage medium whose name is PHYSICALDRIVE:1. According to the test results in Table 1, a storage medium PHYSICALDRIVE:1 in a user terminal PC-1 is tested in 100% write and 0% read test, and the IOps, the Read IOps, and the Write IOps of the storage medium are 165.4697, 0, and 165.4697.

In step S2, number of the storage mediums to be analyzed is set. In the embodiment, some of the storage mediums need to be analyzed and the others do not need after the performance tests of the storage mediums 1-N in the server unit 10 are finished. Therefore, the number of the analyzed storage mediums will be set by the user. In another embodiment, this step can be neglected. When the number of the analyzed storage mediums is not set, each of the storage mediums will be analyzed.

In step S3, at least one predetermined value is set according to at least one interface type of the storage mediums. In the embodiment, it is possible that the interface types of the storage mediums 1-N in the server unit 10 are not the same as each other. For example, both of hard disk drives with a Serial Attached Small Computer System Interface (SCSI) (SAS) interface and hard disk drives with a Serial Advanced Technology Attachment (SATA) interface are conventional hard disk drives. Since the interface types of the storage mediums can influence their performances, the interface types should be considered simultaneously if the analysis method determines whether the performances of the storage mediums 1-N comply with the requests or not.

In step S4, a keyword is set, and a plurality of first values of the storage mediums are read from first results stored in the log files according to the keyword. In the embodiment, the first results in this step are the test results generated by putting the storage mediums in the baseline test. In order to accurately obtain the read/write abilities of the storage mediums, the keyword is determined as the average number of input/output operations per second. Therefore, the first values of the storage mediums can be obtained from row 3, column 3 of the Table 1 according to the keyword. For example, the first value of the storage medium PHYSICALDRIVE:1 is 165.4697. In the embodiment, each of the first values is corresponding to each of the storage mediums.

In step S5, a plurality of second values of the storage mediums are read from second results stored in the log files according to the keyword. In the embodiment, the second results in this step are the test results generated by putting the storage mediums in the rotational vibration test. Since the format of the log files for the rotational vibration test is the same as the format of Table 1, the keyword for the second results can be the same as the keyword for the first results. Therefore, the second values of the storage mediums can be obtained from row 3, column 3 of the Table 1 according to the keyword. Due to the rotational vibration, the read/write abilities of the storage mediums are decreased, so the second values are smaller than the first values. In the embodiment, each of the second values is corresponding to each of the storage mediums

In step S6, a plurality of ratios between the second values and the first values are computed to generate a plurality of third values. In the embodiment, the performances of the storage mediums are shown by the third values. In the embodiment, each of the third values is corresponding to each of the storage mediums.

In the embodiment, if the number of the storage mediums to be analyzed is set, the number of the analyzed storage mediums is equal to the number of the read first values, to the number of the read second values, and to the number of the computed ratios.

In step S7, the analysis method determines whether each of the third values is smaller than a corresponding predetermined value or not. For example, the procedure goes to step S8 if the third value of the storage medium PHYSICALDRIVE:1 is smaller than the predetermined value of the storage medium PHYSICALDRIVE:1. If the third value of the storage medium PHYSICALDRIVE:1 is not smaller than the predetermined value of the storage medium PHYSICALDRIVE:1, the procedure ends.

In the embodiment, the third values of the storage mediums will be compared with the predetermined values of the storage mediums according to the types of the storage mediums when the analysis method determines whether the performances of the storage mediums comply with the requests or not. If some of the third values are smaller than the predetermined values, the corresponding storage mediums do not comply with the requests.

In step S8, the third value is marked when the third value is smaller than the predetermined value. In the embodiment, a background color of the third value can be changed from no color to red so that the storage medium which does not comply with the requests can be easily recognized. Therefore, it is convenient for the users to understand the performances of the storage mediums 1-N in the server unit 10.

The analysis method can read the first results and the second results of the storage mediums in the log files according to the keyword, obtain the first values and the second values from the first results and the second results, and compute the ratios between the second values and the first values to generate the third values. Then, the analysis method can compare the third values with the predetermined values of the storage mediums corresponding to the types of the storage mediums. When the third values are smaller than the predetermined values, the third values are marked. Therefore, the performances of the storage mediums can be analyzed quickly and automatically from the test log files, and the storage mediums which do not comply with the requests can be conveniently and directly recognized by the user according to the marked values.

While the disclosure has been described by way of example and in terms of various embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A method for analyzing a plurality of storage mediums in a server unit, comprising:
storing a plurality of first results generated by testing the plurality of storage mediums in a first test and a plurality of second results generated by testing the plurality of storage mediums in a second test;
setting at least one predetermined value according to at least one type of the plurality of storage mediums;
setting a keyword;
reading a plurality of first values from the plurality of first results and a plurality of second values from the plurality of second results according to the keyword, wherein each of the plurality of first values and each of the plurality of second values are related to a corresponding storage medium;
generating a plurality of third values, wherein each of the plurality of third values is a ratio between a corresponding second value and a corresponding first value; and
marking one of the plurality of third values when the one of the plurality of third values is smaller than a corresponding predetermined value corresponding to the one of the plurality of storage mediums.

2. The method of claim 1, further comprising:
setting number of the plurality of storage mediums to be analyzed.

3. The method of claim 2, wherein the number of the plurality of storage mediums to be analyzed is equal to the number of the plurality of first values, to the number of the plurality of second values, and to the number of the plurality of third values.

4. The method of claim 1, wherein the first test and the second test are performance tests for the plurality of storage mediums, and the performance tests are operated by a test software.

5. The method of claim 1, wherein the first test is a baseline test, and the second test is a rotational vibration test.

6. The method of claim 5, wherein the baseline test is that one of the plurality of storage mediums is tested when the others stop operating.

7. The method of claim 5, wherein the rotational vibration test is that one of plurality of the storage mediums is tested when each of the plurality of storage mediums is being operating.

8. The method of claim 1, wherein the at least one type is selected from a group consisting of Serial Advanced Technology Attachment (SATA), Serial Attached Small Computer System Interface (SCSI) (SAS) and the combination thereof.

9. A method for a first storage medium in a server unit, comprising:
storing a first result generated by testing the first storage medium in a first test and a second result generated by testing the first storage medium in a second test;
setting a predetermined value according to a type of the first storage medium;
setting a keyword;
reading a first value from the first result and a second value from the second result according to the keyword;
computing a ratio between the second value and the first value to generate a third value;
determining whether the third value is smaller than the predetermined value; and
marking the third value when the third value is smaller than the predetermined value.

10. The method of claim 9, wherein the first test is a baseline test, the second test is a rotational vibration test, and the server unit further includes a second storage medium.

11. The method of claim 10, wherein the baseline test is that the first storage medium is tested when the second storage medium stops operating.

12. The method of claim 10, wherein the rotational vibration test is that the first storage medium is tested when both of the first and the second medium are being operating.
